(19) United States
(12) Patent Application Publication
(10) Pub. No.: US 2026/0265602 A1
(43) Pub. Date: Sep. 10, 2026

(54) Method for Generating CO2 In Situ for Oilfield Applications Using Propylene Carbonate

(71) Applicant: Baker Hughes Oilfield Operations LLC, Houston, TX (US)

(72) Inventors: Frances Debenedictis, Houston, TX (US); Naima Bestaoui-Spurr, The Woodlands, TX (US)

(73) Assignee: Baker Hughes Oilfield Operations LLC, Houston, TX (US)

(21) Appl. No.: 19/666,011

(22) Filed: May 1, 2026

Related U.S. Application Data
(63) Continuation-in-part of application No. 18/626,253, filed on Apr. 3, 2024, now Pat. No. 12,637,931.

(51) Int. Cl. C09K 8/594; C09K 8/42; C09K 8/44

(52) U.S. Cl. CPC C09K 8/594; C09K 8/426; C09K 8/44; C09K 2208/18

(57) ABSTRACT

A method for generating CO₂ gas in situ involves introducing propylene carbonate into a target zone, where the propylene carbonate decomposes to produce the CO₂ gas. The CO₂ gas is subsequently used for a treatment objective or chemical reaction, such as an enhanced oil recovery operation, a condensate blocking treatment, or a gas lift operation. The method may also involve introducing a catalyst to decompose the propylene carbonate that would otherwise be stable within the target zone and/or introducing a diverting system that fully or partially obstructs a zone of higher permeability than the target zone.

### RELATED APPLICATIONS

This application is a continuation-in-part of U.S. patent application Ser. No. 18/626,253 filed Apr. 3, 2024, entitled “Method for Generating CO₂ In Situ for Oilfield Applications Using Propylene Carbonate,” the disclosure of which is herein incorporated by reference.

### FIELD OF THE INVENTION

This invention generally relates to CO₂ production and, more particularly, but not by way of limitation, to a method for generating CO₂ in situ for oilfield applications using propylene carbonate.

### BACKGROUND OF THE INVENTION

Carbon dioxide is used in many oilfield applications, from generating foams for drilling to cementing, fracturing and acid stimulation treatments, and enhanced oil recovery (EOR). Although the cost to purchase liquid carbon dioxide (CO₂) is relatively low, the transportation costs and Health, Safety and Environment (HSE) risks are high.

Propylene carbonate is an environmentally friendly solvent available for various oilfield applications. The primary decomposition products of propylene carbonate include propylene glycol oxide, propionaldehyde, allyl alcohol and CO₂. Using propylene carbonate as an in-situ source of CO₂ could reduce the HSE risks and other challenges related to transporting CO₂ to the location where it is intended to be used. Some studies have attempted the conversion of propylene carbonate to CO₂ at bottom hole temperature (BHT) and bottom hole pressure (BHP) through natural degradation processes. These studies have been generally unsuccessful due to the stability of propylene carbonate at higher temperatures (up to about 250° C.).

A need exists, therefore, for effective methods to convert propylene carbonate to CO₂ at high temperatures, such as those experienced under bottom hole conditions. The present disclosure is directed at these and other deficiencies in the prior art.

### SUMMARY OF THE INVENTION

The inventive concepts disclosed herein are generally directed to methods for generating CO₂ gas in situ for use in a treatment objective or chemical reaction.

In some embodiments, the present disclosure is directed at a method for generating CO₂ gas in situ. The method involves introducing propylene carbonate into a target zone, where the propylene carbonate decomposes at the target zone to produce the CO₂ gas. The CO₂ gas is subsequently used to pursue a treatment objective, such as one or more of the following treatment objectives: an enhanced oil recovery operation, a condensate blocking treatment, or a gas lift operation at the target zone with the CO₂ gas.

In other embodiments, the present disclosure is directed at a method of generating CO₂ gas in situ, where the method includes the step of introducing propylene carbonate and a catalyst into a target zone, where the propylene carbonate would be stable within the target zone absent the catalyst and where the catalyst decomposes the propylene carbonate to produce the CO₂ gas. The method further includes the step of conducting a treatment objective with the CO₂ gas, namely an enhanced oil recovery operation, a condensate blocking treatment, or a gas lift operation at the target zone.

In yet other embodiments, the present disclosure is directed at a method of generating CO₂ gas in situ within a target zone of a well. The method involves introducing a diverting system to fully or partially obstruct a zone of higher permeability than the target zone and thereafter introducing propylene carbonate into the target zone. The propylene carbonate is maintained within the target zone for a pre-determined decomposition period during which the propylene carbonate decomposes to produce the CO₂ gas. The CO₂ gas is used to conduct a treatment objective, such as an enhanced oil recovery operation, a condensate blocking treatment, or a gas lift operation at the target zone.

### BRIEF DESCRIPTION OF DRAWINGS

The above and other objects and advantages of this invention may be more clearly seen when viewed in conjunction with the accompanying drawing wherein:

FIG. 1 depicts an exemplary well site that is suitable for treatment using an embodiment of the method for generating CO₂ using propylene carbonate.

### DETAILED DESCRIPTION

It has been discovered that propylene carbonate may be effectively decomposed under some downhole conditions to produce CO₂ gas usable for one or more treatment objectives or chemical reactions. In downhole conditions that fall outside these high temperatures, propylene carbonate may not satisfactorily decompose to produce CO₂ gas. For wells that exhibit downhole conditions that are not favorable for propylene carbonate decomposition, it has been found that combining propylene carbonate with certain catalysts decomposes the propylene carbonate to CO₂ at temperatures at which the propylene carbonate would typically be stable. By selectively contacting propylene carbonate with a catalyst (e.g., through a delayed release mechanism), CO₂ can be generated in situ for various reactions and treatment objectives within the oilfield, including but not limited to, cementing, fracturing, performing acid stimulation treatments, generating foams for drilling or EOR operations, conducting EOR operations (e.g., gas-based EOR operations) to increase production, mitigating condensate blocking, and creating gas lift to aid in fluid recovery. In other exemplary applications, propylene carbonate decomposes at high temperatures (e.g., between about 250° C. and about 450° C.) without a catalyst by maintaining the propylene carbonate said high temperatures for a pre-determined decomposition period.

Based on the foregoing, a method for generating CO₂ in situ for oilfield applications involves introducing propylene carbonate into a target zone, where the propylene carbonate decomposes to produce a CO₂ gas that can be used to perform a desired treatment objective or chemical reaction. In various embodiments, the target zone is at a wellbore, the near-wellbore region, or a formation, where suitable target zones include but are not necessarily limited to a wellbore tubular, a wellhead, production tubing, or downhole equipment. Other suitable target zones include process equipment, a process tank and conduit, a pipeline, or a storage tank.

In some applications, the method involves introducing both propylene carbonate and a catalyst into the target zone, where the catalyst reacts with and decomposes the propylene carbonate to produce the CO₂. The CO₂ gas can then be used to perform a desired treatment objective or chemical reaction.

The propylene carbonate and the catalyst can be introduced into the target zone in any order or simultaneously. In some embodiments, the propylene carbonate is introduced into the target zone before the catalyst. The timing of catalyst introduction in such embodiments may be used to delay propylene carbonate decomposition strategically, such that CO₂ is generated within the desired target zone but not outside of said target zone. In other embodiments, the propylene carbonate is introduced after the catalyst, such that the propylene carbonate and catalyst initially come into contact within the target zone. Multiple alternating volumes of propylene carbonate and catalyst can also be used to generate CO₂. For example, one embodiment introduces a first volume of propylene carbonate into the target zone, followed by a first volume of catalyst, a second volume of propylene carbonate, and a second volume of catalyst in series. In another embodiment, a first volume of catalyst is introduced into the target zone, followed by a first volume of propylene carbonate, a second volume of catalyst, and a second volume of propylene carbonate in series. It will be appreciated that the first and second volumes of propylene carbonate treatments may have either the same or different concentrations of propylene carbonate. Similarly, the first and second volumes of treatments can include the same or different concentrations of the catalyst, or different catalysts altogether. In various embodiments, 1, 2, 3, 4, 5, 6, 7, 8, 9, 10, 11 or 12 volumes of propylene carbonate are alternated with corresponding volumes of the catalyst or catalysts. In some embodiments, alternating or simultaneous volumes of propylene carbonate and of the catalyst are introduced continuously into the target zone. In other embodiments, volumes of propylene carbonate and of the catalyst are repetitively introduced to the target zone based on present need or at a pre-determined interval of time (e.g., ten minutes, thirty minutes, an hour, twenty-four hours, a week, etc.).

In other embodiments, the propylene carbonate and the catalyst are introduced into the target zone as a single formulation. In such embodiments, a delayed release mechanism may be employed to prevent decomposition of the propylene carbonate in the formulation prior to it reaching the target zone. For example, release of the catalyst into the target zone may be controlled by a coating or an adsorbent matrix or substrate to delay decomposition of the propylene carbonate by the catalyst. In various wells, the target zone has a temperature of between about 15° C. and about 450° C. For many of these wells, the target zone has a temperature of between about 15° C. and about 315° C. or between about 150° C. and about 450° C. For target zones with temperatures between about 250° C. and about 450° C., propylene carbonate decomposition may be accomplished without the use of a catalyst. In some embodiments, propylene carbonate is maintained within a high-temperature target zone for a pre-determined decomposition period to facilitate decomposition without a catalyst. At a temperature of about 250° C., for example, the pre-determined decomposition period may be between about 1 hour and about 5 hours. At higher temperatures, such as above about 300° C., the pre-determined decomposition period will be shorter (e.g., between about 5 seconds and about 60 seconds).

In embodiments in which a catalyst is used for propylene carbonate decomposition, the catalyst may be a solid, a liquid, or a combination thereof. In certain embodiments where the catalyst is a solid, it can be dissolved in a suitable solvent, thus making it a liquid catalyst. In other embodiments where the catalyst is a solid, the catalyst is disposed on a high-surface-area solid, such as a molecular sieve, diatomaceous earth, zeolite, high-surface-area metal composite, high-surface-area organic polymer on a composite, high-surface-area silica or alumina silicate, or a metal-organic framework material.

Suitable catalysts include metal oxides and metal nanoparticles, such as platinum-based nanoparticles, nickel-based nanoparticles, copper-based nanoparticles, cobalt-based nanoparticles, gold-based nanoparticles, and palladium-based nanoparticles. The catalysts can also include acids, bases, salts, and combinations thereof. Suitable acids include hydrochloric acid, citric acid, acetic acid, formic acid, dodecyl benzene sulfonic acid, succinic acid, adipic acid, glutaric acid, and mixtures thereof. Suitable bases include sodium hydroxide, potassium hydroxide, sodium carbonate, sodium bicarbonate, ammonia, sodium hypochlorite, monoethanolamine, diethanolamine, and mixtures thereof. In various embodiments, the salt is potassium chloride, sodium chloride, ammonium chloride, sodium bromide, cobalt acetate, quaternary ammonium salt, phosphonium salt, or a mixture thereof.

In one embodiment, the propylene carbonate and the catalyst are injected into the target zone in a ratio of between about 99.999:0.001 and about 50:50 (propylene carbonate:catalyst). In another embodiment, the ratio of propylene carbonate to catalyst injected into the target zone is between about 99.99:0.01 and about 94:6.

The propylene carbonate, the catalyst, or both can be injected to the target zone in a concentrated form. For formation and wellbore applications, the concentrated form can be applied to the impacted region by stimulation methods such as bullheading, coiled tubing, injection through capillary tubing, chemical injection plunger, or other treatment chemical delivery mechanisms. For application to surface-based equipment or facilities, the propylene carbonate or catalyst can be applied by pumping, spraying, soaking, or otherwise contacting the equipment/facilities with the concentrated form.

Alternatively, the propylene carbonate, the catalyst, or both can be mixed with a suitable carrier fluid and pumped into the wellbore or through surface-based facilities and equipment. The carrier fluid may be water, brine, or another aqueous solution. In general, the propylene carbonate may be mixed into the carrier fluid in any proportion. In some embodiments, the catalyst is mixed into the carrier fluid in a concentration range of between about 1 ppm and about 500,000 ppm (catalyst to carrier fluid). In other embodiments, the concentration range is between about 1 ppm and about 6,000 ppm.

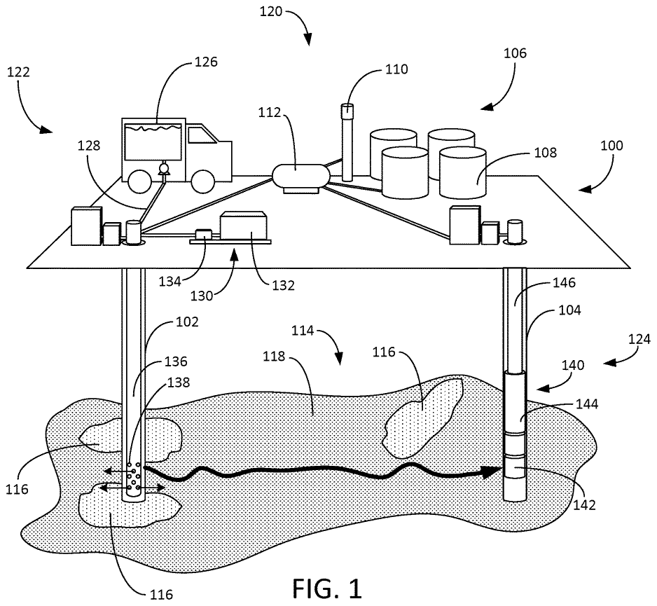

With reference to FIG. 1, shown therein is a depiction of a well site 100 that includes an injection well 102, a production well 104, and a surface processing facility 106. The surface processing facility 106 can include, for example, a tank battery 108, a flare 110, and a separator 112. Generally, the injection well 102 is used for the emplacement of treatment fluids underground, and the production well 104 is used to produce petroleum products or other fluids, which are then separated, stored and discarded using the surface processing facility 106. The injection well 102 and production well 104 extend within a subterranean formation 114 containing various high permeability zones 116 and low permeability zones 118.

A fluid recovery system 120 is used to both emplace fluids within the formation 114 using the injection well 102 and to produce petroleum products, water or other fluids from the production well 104. In the embodiment depicted in FIG. 1, the fluid recovery system 120 includes a chemical treatment system 122 and a pumping system 124.

The chemical treatment system 122 includes a treatment truck 126 that can be connected directly or indirectly to the injection well 102 to deliver treatment chemicals through lines or manifolds. In some embodiments, the treatment truck 126 is connected directly to the injection well 102 through a surface line 128, as depicted in FIG. 1. In other embodiments, the treatment truck 126 delivers chemicals to a chemical injection skid 130 that includes a chemical tank 132 and an injection pump 134, which cooperate to deliver the treatment chemicals to the injection well 102. Tubing 136 within the injection well 102 directs the treatment chemicals to the desired depth, where the chemicals exit into the surrounding formation 114 through a plurality of perforations 138.

The pumping system 124 is configured to assist with the removal of target fluids from the production well 104. In some embodiments, the pumping system 124 utilizes an electric submersible pump 140 that is installed in the production well 104 and includes an electric motor 142 and a pump 144, as depicted in FIG. 1. The pump 140 can be connected to production tubing 146, which extends out of the production well 104 to the surface, where it is connected to the processing facility 106.

In some embodiments, propylene carbonate is introduced into a target zone within the subterranean formation 114 by pumping the propylene carbonate (e.g., continuous injection over a predetermined treatment period or through bulk volume injection) at the injection well 102. Propylene carbonate may, additionally or alternatively, be introduced into the production well 104 using, for example, the pumping system 124. In one embodiment, a first volume of propylene carbonate is introduced into the injection well 102 while a second volume of propylene carbonate is simultaneously introduced into the production well 104.

One or more delayed release mechanisms may be used to delay degradation of the propylene carbonate by the catalyst until both reach the target zone. In some embodiments, the catalyst itself decomposes before it is used to promote the degradation of propylene carbonate to CO₂ gas. For example, a solid catalyst may be configured to decompose when it is heated within the target zone and reaches a decomposition temperature, after which at least one product from the catalyst decomposition is used to promote propylene carbonate degradation.

In other embodiments, the catalyst is loaded or immobilized onto a surface of a support matrix or within one or more pores of a porous or high surface area support. For example, the catalyst may be adsorbed onto an adsorbent matrix, such as a water-insoluble substrate, an oil-insoluble substrate, or an adsorbent substrate that is both water and oil-insoluble. A portion of the catalyst may further be absorbed into interstitial spaces of the support. After arrival at the target zone, the catalyst is released (or desorbed) from the support over time. Release of the catalyst into the target zone may be controlled by the presence of a coating. The coating may be applied by low temperature curing methods as well as indirect heating processes. In one embodiment, at least a portion of the surface of the support or porous support is covered with a coating that includes an organic polymer or inorganic material. In various embodiments, the coating is polyvinyl alcohol (PVA), guar, carboxymethyl-glucan (CMG), or polyacrylic acid (PAA).

The organic polymer may be cured, partially cured, or uncured. Suitable organic polymers include thermoplastics as well as thermosetting resins. Exemplary thermoplastics include polyethylene, acrylonitrile-butadiene styrene, polystyrene, polyvinyl chloride, fluoroplastics, polysulfide, polypropylene, styrene acrylonitrile, nylon, and phenylene oxide. Exemplary thermosetting resins include epoxy resins, phenolic resins, melamine formaldehyde resins, polyester resins, polyurethanes, epoxy-modified phenolic resin, and derivatives thereof. The organic polymer may be crosslinked.

Suitable inorganic materials include inorganic compounds such as those containing metal. In a preferred embodiment, the metal is zirconium or zinc. Exemplary inorganic materials include zirconium silicate as well as zinc silicate.

The coating typically ensures the catalyst is not released until elevated stress levels are reached. To release the catalyst at the target zone, at least one crack or fissure is created in the coating. Release of the catalyst from the support through the crack(s) or fissure(s) may occur when an applied stress exceeds the maximum stress and crush resistance that the coating can withstand before showing some cracks. In one embodiment, mechanical stress is applied to the support to create the desired crack(s) or fissure(s). Mechanical stress is achieved in various embodiments by slickwater fracturing, hydraulic fracturing, acid fracturing, or frac packing. In another embodiment, the coating is configured to develop at least one crack or fissure when it is heated within the target zone and reaches a release temperature.

The catalyst is released from the support or porous support, passes through at least one crack or fissure created in the coating, and becomes exposed within the target zone, where the catalyst reacts with and decomposes the propylene carbonate to CO₂ gas.

In some embodiments, the CO₂ gas is used to perform a desired treatment objective or chemical reaction within the target zone. In other embodiments, the CO₂ is recovered from the target zone and used elsewhere for the desired treatment objective or chemical reaction. The desired treatment objective or chemical reaction may be related to cementing, fracturing, performing acid stimulation treatments, generating foams, conducting EOR operations (e.g., gas huff-and-puff, continuous injection, steam injection), mitigating condensate blocking, or creating gas lift to aid in fluid recovery.

In some embodiments, the CO₂ is contacted with a foam-generating surfactant to generate foam for drilling or enhanced oil recovery. The foam-generating surfactant may be injected into the target zone before, during, or after the injection of propylene carbonate. Suitable foam-generating surfactants include viscoelastic surfactants such as cationic amines, C18-C28 fatty amine salts, amine oxides, zwitterionic or amphoteric surfactants, methyl ester sulphonate surfactants, and gemini surfactants. Such foam-generating surfactants create foam upon contact and mixing with the generated CO₂ gas.

In other embodiments, propylene carbonate is pumped into a mature well to increase oil production in connection with an EOR operation. The propylene carbonate, when introduced downhole, provides a source of CO₂ that can be used to stimulate or one or more wells within a well site to improve hydrocarbon production. In various implementations, the propylene carbonate is pumped either into a production well, into an injection well, or into both the production and injection wells to improve oil migration to the wellbore of the production well. The target zone may be a low permeability zone of a subterranean formation. The pressurized CO₂ gas generated from the propylene carbonate may be used to reduce the viscosity of the target oil and sweep said oil through the low permeability target zone toward a production well. The CO₂ gas that is generated from the propylene carbonate is optionally followed by high pressure water injection to push the CO₂ gas through the well site. The generated CO₂ gas may be cycled to further increase recovery.

A chemical or physical diverting system may be used to enhance hydrocarbon recovery by directing propylene carbonate from high permeability zones within the formation to one or more lower permeability target zones. For example, where the target zone is a low permeability zone of a fracture within a subterranean formation, a diverting system may be introduced to plug, bridge, or otherwise partially or fully obstruct a high permeability zone of said fracture. This obstruction redirects propylene carbonate to the desired target zone, thereby increasing productivity within the fracture network.

The diverting system may be introduced downhole via an injection well, a production well, or both. In some instances, the diverting system is introduced to a zone of higher permeability than the target zone before the propylene carbonate treatment is introduced downhole (with or without a catalyst), such that the diverting system facilitates introduction of the propylene carbonate treatment into the target zone as opposed to the zone of higher permeability. In other instances, the diverting system is introduced simultaneously with a volume of propylene carbonate. The diverting system may be introduced with an initial volume of propylene carbonate, followed up with the introduction of a second volume of propylene carbonate. After propylene carbonate decomposition at the target zone, the diverting system and generated CO₂ gas may be cyclically injected to optimize the enhanced oil recovery.

The diverting system includes one or more diverters, where suitable diverters include as viscoelastic surfactant (VES) diverters, polymer diverters, or solid particulates.

Suitable VES diverters include non-polymeric viscoelastic surfactants, such as cationic amines, C18-C28 fatty amine salts, amine oxides, zwitterionic/amphoteric surfactants, methyl ester sulphonate surfactants (e.g., sulfonated fatty ester methyl ester sulfonate), gemini surfactants (e.g., dual-tail cationics), and combinations of the same.

Suitable cationic amines include oleylamine salts and erycylamine salts.

Suitable amine oxides include long-chain amine oxides and amidoamine oxides. Examples of suitable amidoamine oxide VES diverters include tallow amidoalkylamine oxides, hardened tallow amidoalkylamine oxides, rapeseed amidoalkylamine oxide, hardened rapeseed amidoalkylamine oxide, tall oil amidoalkylamine oxide, hardened amidoalkylamine oxide, coco amidoalkylamine oxide, stearyl amidoalkylamine oxide, oleyl amidoalkylamine oxide, soya amidoalkylamine oxide, and mixtures thereof.

Suitable zwitterionic/amphoteric surfactants include alkyl sulfobetaines such as erucamidopropyl hydroxyalkyl sulfobetaines, including erucamidopropyl hydroxypropyl sulfobetaine, erucamidopropyl hydroxyethyl sulfobetaine, and erucamidopropyl hydroxymethyl sulfobetaines. Other suitable zwitterionic/amphoteric surfactants include dihydroxyl alkyl glycinate, alkyl amphoacetate or propionate, alkyl betaine, alkyl amidopropyl betaine and alkylimino mono- or di-propionates.

Turning to polymer diverters, suitable non-limiting examples include unimodal or multimodal polymeric mixtures of ethylene or other suitable, linear or linear, branched alkene plastics, such as isoprene, propylene, and the like. Other suitable polymer diverters include aqueous-swellable particles such as polyacrylate-cellulose graft copolymer, collagen, chitin, chitosan, dextran, carboxymethyldextran, starch, hydrolyzed polyacrylonitrile, starch-methacrylonitrile graft copolymer, polyacrylamide, potassium salt of polyacrylic acid or alginic acid, and carboxymethylcellulose.

Suitable solid particulates include dissolvable solid particulates that dissolve over time at in-situ reservoir conditions. Exemplary dissolvable solid particulates include phthalic anhydride, terephthalic anhydride, phthalic acid, terephthalic acid, gilsonite, rock salt, benzoic acid flakes, polylactic acid and mixtures thereof. Other suitable diverters include substantially dehydrated or anhydrous sodium perborate and substantially dehydrated or anhydrous sodium borate.

In some embodiments, the combination of the propylene carbonate and one or more catalysts and/or diverters presents a treatment package that can be used for generating CO₂ in situ for one or more treatment objectives. The treatment package can include a plurality of catalysts selected from those disclosed herein, including metal oxides, metal nanoparticles, acids, bases, and salts. The treatment package may also include one or more VES diverters, polymer diverters, or solid particulates.

In some embodiments, propylene carbonate is introduced into a target zone in which condensate blocking has occurred to reduce or eliminate said condensate blocking. The generation of CO₂ gas from the propylene carbonate increases pressure within the well, thereby reestablishing gasification of the condensate. Alternatively, propylene carbonate may be injected and the generated CO₂ gas cycled through a target zone to prevent condensate blocking by increasing and/or maintaining the reservoir pressure above the dew point. Such treatments are well-suited for gas wells in which where the pressure is below the dew point and, therefore, susceptible to condensate blocking.

In some embodiments, propylene carbonate is introduced into a well to create gas lift for improved fluid recovery. Propylene carbonate may be continuously or intermittently injected into a target zone with a solid catalyst that converts said propylene carbonate to CO₂ gas, thereby increasing pressure within the well and increasing viscosity of fluid therein.

### EXAMPLES

The method for generating CO₂ in situ for oilfield applications using propylene carbonate is further illustrated by the following examples, which are provided for the purpose of demonstration rather than limitation.

### Example 1

In a first round of tests, propylene carbonate was combined with various solvents, and it was observed that certain samples decomposed and generated CO₂. More particularly, it was determined that an aqueous solution of propylene carbonate in the presence of acids, bases, metal oxides, or salts caused the decomposition of the propylene carbonate to gas, with the rate of decomposition generally increasing with increasing temperature. The primary decomposition products of propylene carbonate included propylene glycol oxide, propionaldehyde, allyl alcohol and carbon dioxide.

Table 1 demonstrates various sourced samples of 90 wt. % propylene carbonate (PC) and 10 wt. % water from different sources formulated in acidic, basic, and neutral solutions. Samples 1, 4, and 7 were formulated with a drop of dodecyl benzene sulfonic acid (DDBSA). Samples 2, 5, and 8 were neutral formulations. Samples 3, 6, and 9 were formulated with a drop of 5% sodium hydroxide.

TABLE 1

| | PC | PC | PC | | | |
|---|---|---|---|---|---|---|
| Sample | Sample | Sample | Sample | | DDBSA | 5% NaOH |
| No. | 1 (g) | 2 (g) | 3 (g) | Water (g) | (drops) | (drops) |
| 1 | 9 | | | 1 | 1 | |
| 2 | 9 | | | 1 | | |
| 3 | 9 | | | 1 | | 1 |
| 4 | | 9 | | 1 | 1 | |
| 5 | | 9 | | 1 | | |
| 6 | | 9 | | 1 | | 1 |
| 7 | | | 9 | 1 | 1 | |
| 8 | | | 9 | 1 | | |
| 9 | | | 9 | 1 | | 1 |

Sound was used to determine gas production in each of Samples 1-9 because the gas could not be visualized. As shown in Table 2, it was determined that the acidic and basic solutions produced gas after 24 hours of incubation at 50° C., while the neutral solutions did not.

TABLE 2

| Sample No. | Results observed after 24 hours at 50° C. | pH Description |
|---|---|---|
| 1 | Pressure sound, but no visible foaming | Acidic |
| 2 | No pressure sound | Neutral |
| 3 | Pressure sound, but no visible foaming | Basic |
| 4 | Pressure sound, but no visible foaming | Acidic |
| 5 | No pressure sound | Neutral |
| 6 | Pressure sound, but no visible foaming | Basic |
| 7 | Pressure sound, but no visible foaming | Acidic |
| 8 | No pressure sound | Neutral |
| 9 | Pressure sound, but no visible foaming | Basic |

In summary, the performed tests indicated that the acidic and basic solutions decomposed propylene carbonate to gas, where the decomposition products included CO₂.

In the foregoing specification, the invention has been described with reference to specific embodiments thereof. However, it will be evident that various modifications and changes can be made thereto without departing from the broader scope of the invention as set forth in the appended claims. Accordingly, the specification is to be regarded in an illustrative rather than a restrictive sense. For example, catalysts, target zones, coatings, supports, porous supports, mechanical stresses, treatment procedures, proportions, dosages, temperatures, and amounts not specifically identified or described in this disclosure or not evaluated in a particular Example are still expected to be within the scope of this invention.

The present invention may suitably comprise, consist of, or consist essentially of the elements disclosed and may be practiced in the absence of an element not disclosed. As used herein, the singular forms “a,” “an,” and “the” are intended to include the plural forms as well, unless the context clearly indicates otherwise. As used herein, the term “about” in reference to a given parameter is inclusive of the stated value and has the meaning dictated by the context (e.g., it includes the degree of error associated with measurement of the given parameter). As used herein, the term “and/or” includes any and all combinations of one or more of the associated listed items.

It is claimed:

1. A method of generating CO₂ gas in situ, the method comprising the steps of
introducing propylene carbonate into a target zone, wherein the propylene carbonate decomposes at the target zone to produce the CO₂ gas; and
conducting a treatment objective selected from the group consisting of an enhanced oil recovery operation, a condensate blocking treatment, and a gas lift operation at the target zone with the CO₂ gas.

2. The method of claim 1, wherein the step of introducing the propylene carbonate into the target zone comprises injecting the propylene carbonate into an injection well.

3. The method of claim 2, wherein the step of injecting the propylene carbonate into the injection well comprises continuous injection over a predetermined treatment period.

4. The method of claim 2, wherein the step of introducing the propylene carbonate into the target zone further comprises injecting a second volume of the propylene carbonate into a production well.

5. The method of claim 1, wherein the step of conducting the treatment objective comprises conducting an enhanced oil recovery operation.

6. The method of claim 5, wherein the target zone is a low permeability zone of a fracture within a subterranean formation.

7. The method of claim 6, further comprising introducing a diverting system to fully or partially obstruct a high permeability zone of the fracture before the step of introducing the propylene carbonate into the target zone.

8. The method of claim 7, wherein the step of conducting the enhanced oil recovery operation comprises cyclic injection of the diverting system and the CO₂ gas.

9. The method of claim 7, wherein the diverting system comprises one or more diverters selected from the group consisting of viscoelastic surfactant diverters, polymer diverters, and solid particulates.

10. The method of claim 9, wherein the diverting system comprises a viscoelastic surfactant diverter selected from the group consisting of cationic amines, C18-C28 fatty amine salts, amine oxides, zwitterionic or amphoteric surfactants, methyl ester sulphonate surfactants, and gemini surfactants.

11. The method of claim 1, wherein the step of conducting the treatment objective comprises conducting a gas lift operation at the target zone.

12. The method of claim 11, wherein the step of conducting the gas lift comprises contacting the propylene carbonate with a solid catalyst within the target zone.

13. The method of claim 1, further comprising contacting the CO₂ gas with a foam-generating surfactant.

14. A method of generating CO₂ gas in situ, the method comprising the steps of:
introducing propylene carbonate and a catalyst into a target zone, wherein the propylene carbonate would be stable within the target zone absent the catalyst and wherein the catalyst decomposes the propylene carbonate to produce the CO₂ gas; and
conducting a treatment objective selected from the group consisting of an enhanced oil recovery operation, a condensate blocking treatment, and a gas lift operation at the target zone with the CO₂ gas.

15. The method of claim 14, further comprising introducing a diverting system into a zone of higher permeability than the target zone before the step of introducing the propylene carbonate and the catalyst into the target zone.

16. The method of claim 15, wherein the diverting system fully or partially obstructs the zone of higher permeability, thereby directing the propylene carbonate into the target zone.

17. The method of claim 15, wherein the step of introducing the diverting system comprises simultaneously introducing the diverting system and an initial volume of propylene carbonate into the zone of high permeability.

18. The method of claim 14, further comprising the step of introducing a viscoelastic surfactant into the target zone, wherein said viscoelastic surfactant creates foam with the CO₂ gas.

19. A method of generating CO₂ gas in situ, the method comprising the steps of:
introducing a diverting system to fully or partially obstruct a zone of higher permeability than a target zone;
introducing propylene carbonate into the target zone;
maintaining the propylene carbonate within the target zone for a pre-determined decomposition period during which the propylene carbonate decomposes to produce the CO₂ gas; and
conducting a treatment objective selected from the group consisting of an enhanced oil recovery operation, a condensate blocking treatment, and a gas lift operation at the target zone with the CO₂ gas.

20. The method of claim 19, further comprising the step of introducing a catalyst into a target zone, wherein the propylene carbonate would be stable within the target zone absent the catalyst and wherein the catalyst decomposes the propylene carbonate to produce the CO₂ gas.
